(19) United States
(12) Patent Application Publication
(10) Pub. No.: US 2008/0002034 A1
(43) Pub. Date: Jan. 3, 2008

(54) Image output system

(76) Inventor: Chia-Lin Tsai, Chupei City (TW)

Correspondence Address: BIRCH STEWART KOLASCH & BIRCH, PO BOX 747, FALLS CHURCH, VA, 22040-0747, US

(21) Appl. No.: 11/476,642

(22) Filed: Jun. 29, 2006

(51) Int. Cl. H04N 5/228

(52) U.S. Cl. 348/222.1

(57) ABSTRACT

An image output system includes a phase comparator, an image synchronous signal generator, and a video encoder. The phase comparator receives a digital signal and a vertical synchronous signal and compares their period and phase to generate a clock correction signal, where the digital signal is converted from an analog signal through a voltage comparator (or the analog-to-digital conversion). The image synchronous signal generator receives the clock correction signal, generates the vertical synchronous signal, and adjusts a subsequent period of the vertical synchronous signal according to the clock correction signal. The video encoder receives the vertical synchronous signal and target image data and encodes them to output an analog encoded image data.

### FIELD OF THE INVENTION

The invention relates to an image processing system, and more particularly, to an image output system.

### DESCRIPTION OF THE RELATED ART

FIG. 1 shows a block diagram illustrating a typical monitoring system 10. Referring to FIG. 1, the monitoring system 10 includes four sets of video cameras 111-114, a control system 12, and a display 13. In the monitoring system 10, images of distinct location O1, O2, O3 and O4 acquired from video cameras 111-114 are fed into the display 13 through the control system 12. Hence, the effect of monitoring is then achieved.

Referring to FIG. 2A, the video cameras 111˜114 each include an image processing system 20. The image processing system 20 includes an image output system 20′ (shown in dashed line) and an image acquisition device 23. Further, the image output system 20′ includes a voltage comparator 21, an image synchronous signal generator 22, a video encoder 24, a phase locked loop 25 and a timing generator 26. Note that, in the image processing system 20, a output clock signal P1 generated from the phase locked loop 25 and synchronized with a power source (alternating current) 14 is fed to the image synchronous signal generator 22, the image acquisition device 23 and the video encoder 24 to replace the system clock adopted in a typical digital system. Hence, the image synchronous signal generator 22, the image acquisition device 23 and the video encoder 24 are all synchronized with the power source 14 to achieve the effect of locking the frequency and phase of the power source 14. On the other hand, other components in the image processing system 20 still operate in reference to the original system clock.

The image output system 20′ converts the power source 14 into a digital signal V1 by means of the voltage comparator 21. The phase locked loop 25 analogically multiplies the frequency of the digital signal V1 to a desired operation frequency and generates an output clock signal P1. The image synchronous signal generator 22 receives the output clock signal P1 and generates a vertical synchronous signal VSYNC. Then, the phase locked loop 25 receives the vertical synchronous signal VSYNC and compares it with the digital signal VI to adjust the frequency of the output clock signal P1. Thereby, the frequency of the vertical synchronous signal VSYNC is synchronized with the power source 14. The image acquisition device 23 receives the vertical synchronous signal VSYNC and the output clock signal P1 and generates a target image data T after dealing with a captured image. Then, the video encoder 24 receives the clock signal CK generated from the timing generator 26, the output clock signal P1, and the target image data T and outputs an analog encoded image data O after integrating and encoding these signals.

A conventional way (analog signal processing) of dealing with the monitoring system 10 is that, the images captured from video cameras 111˜114 are outputted by the control system 12 and displayed on the display 13 consecutively. However, the anti-noise capability for the phase locked loop in the conventional image output system 20′, when actually applied, is inferior. Since the anti-noise capability for the phase locked loop 13 is inferior, the output clock signal P1 may fail to lock the frequency of the power source to cause the image synchronous signal generator 22, the image acquisition device 23, and the video encoder 24 to be no longer synchronized with the power source as the noises become considerable. In that case, the display is interfered with undesired image flicker and jitter as the control system 12 changes output images for displaying. Referring to FIG. 3, wherein the symbol “14p” indicates a power signal supplied with the power source 14, the symbols “O1˜O4” indicate analog encoded image data captured from the video cameras 111˜114, and the symbol “13o” indicates a display signal of the display 13. As the noises are relatively negligible, the output clock signal P1 of phase locked loop 25 is synchronous with the frequency of the power source 14 so that the analog encoded image data O1˜O4 are synchronous with that of the power signal 14p. Thereby, as the control system 12 changes output images an image O1′ captured from the video camera 111 is outputted and displayed exactly at time t1, so is that of the video cameras 112˜114 at time t2˜t4 respectively. On the other hand, as the noises become considerable, the phase locked loop 25 may fail to lock the frequency of the power source 14 and causes the analog encoded image data O1˜O4 to be no longer synchronized with the power signal 14p. Hence, timing for displaying images becomes unstable and introduce image disturbance such as flickering and jittering. Referring to FIG. 4, the analog encoded image data O1 leads the power signal 14p and the analog encoded image data O2 lags behind the power signal 14p. Therefore, the timing for displaying is advanced and delayed respectively and the image flicker and jitter may still occur.

Another problem also involves the inferior anti-noise capability for the phase locked loop 25. Referring to FIG. 2B, the video encoder 24 includes a video timing generator 241, a luminance/synchronous signal generator 242, two digital to analog converters 243 and 245, and a chroma/burst signal generator 244. Typically, a chroma/burst signal generator 244 requires a very accurate clock signal to deal with the chroma and the burst managements. On the other hand, the inferior anti-noise capability of the phase lock loop 25 results in an inaccurate and unstable output of the clock signal P1. Under the circumstance, an additional timing generator 26 shown in FIG. 2A is needed to provide a very accurate clock signal CK for the chroma/burst signal generator 244. For example, according to the National Television System Committee (NTSC) video standard, the clock signal CK of the chroma and the burst managements equals 3.579545 MHz and has an accept error of ±5 Hz to conform to the NTSC video standard. Because of this, the luminance/synchronous signal generator 242 and the chroma/burst signal generator 244 need to receive different clock signals and generate different output signals conforming to their respective specification, and thus two digital to analog converters 243 and 245 are needed at a price, higher manufacture cost.

### BRIEF SUMMARY OF THE INVENTION

Hence, an object of the invention is to provide an image output system that synchronizes a system clock signal in the image output system with the frequency of an analog signal generated from a power source, so that the image flicker and jitter are eliminated, and the quality of image is enhanced.

According to the invention, an image output system includes a phase comparator, an image synchronous signal generator, and a video encoder. The phase comparator receives a digital signal and a vertical synchronous signal and compares their period and phase to generate a clock correction signal, where the digital signal is converted from an analog signal through a voltage comparator (or the analog-to-digital conversion).

The image synchronous signal generator receives the clock correction signal, generates the vertical synchronous signal, and adjusts a subsequent period of the vertical synchronous signal according to the clock correction signal. The video encoder receives the vertical synchronous signal and target image data and encodes them to output an analog encoded image data.

Through the design of the invention, the image output system uses the image synchronous signal generator and video encoder to compensate the period of the vertical synchronous signal from the image synchronous signal generator in reference to a digital signal. Hence, the error of the vertical synchronous signal is limited in a very small range, and the vertical synchronous signal is synchronized with the frequency and phase of the analog signal. Accordingly, the vertical synchronous signal is synchronized with the power source even the source is bearing considerable amount of noise. Thereby, the problem which exists in the conventional image output system is that the phase lock loop fails to lock the frequency of the power source and causes image flicker and jitter, is eliminated. Hence, the image output system only needs one digital to analog converter and thus has a reduced cost.

### BRIEF DESCRIPTION OF THE DRAWINGS

FIG. 1 shows a block diagram illustrating a conventional monitoring system.

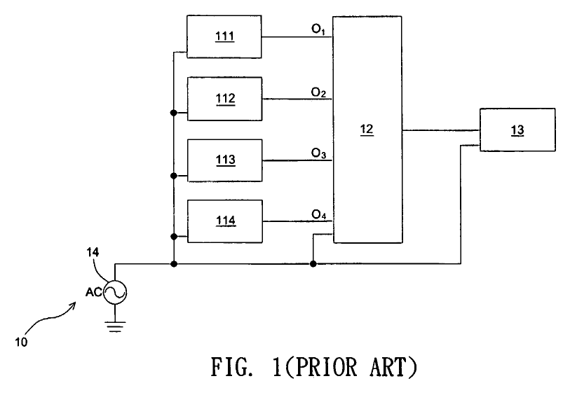

FIG. 2A shows a block diagram illustrating a conventional image processing system.

FIG. 2B shows a block diagram illustrating a conventional video encoder.

FIG. 3 shows a timing diagram illustrating signal transmission according to a conventional monitoring system.

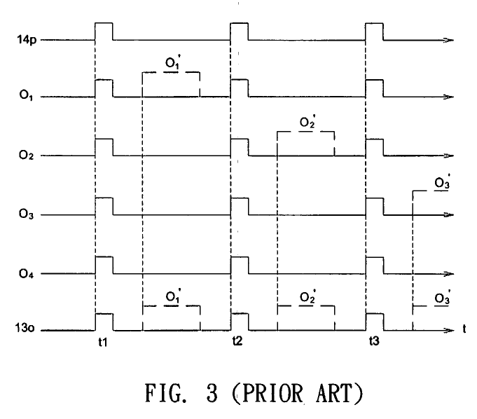

FIG. 4 shows another timing diagram illustrating signal transmission according to a conventional monitoring system.

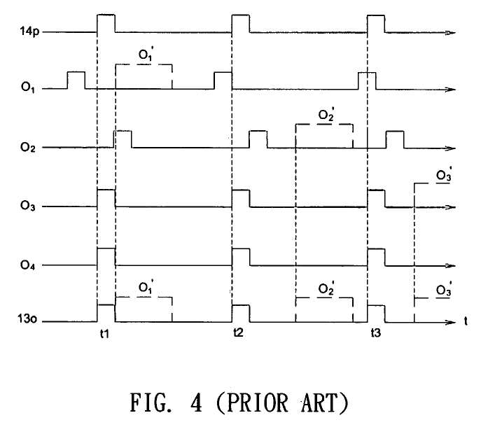

FIG. 5 shows a block diagram illustrating an image processing system according to the invention.

FIG. 6 shows a schematic diagram illustrating a sensor/video period compensation unit according to the invention.

FIG. 7 shows a schematic diagram illustrating another sensor/video period compensation unit according to the invention.

FIG. 8 shows a schematic diagram illustrating a video encoder according to the invention.

### DETAILED DESCRIPTION OF THE INVENTION

The image output system according to the invention will be described with reference to the accompanying drawings.

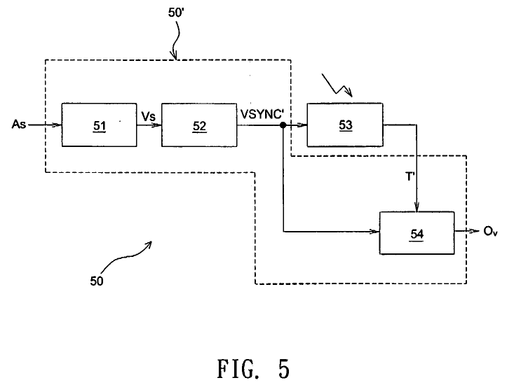

FIG. 5 shows a block diagram illustrating an image processing system according to the invention. The image processing system 50 includes an image output system 50′, and an image acquisition device 53. The image output system 50′ receives a target image data T′ generated from the image acquisition device 53 and outputs an analog encoded image data Ov after dealing with the target image data T′. The image output system 50′ includes a voltage comparator 51, a sensor/video period compensation unit 52, and a video encoder 54. Note that all components in the image processing system 50 operate in reference to the original system clock, which is different compared to conventional image processing system 20. Hence, the system clock received by each component is not additionally indicated in FIG. 5.

The voltage comparator 51 in the image output system 50′ receives an analog signal As and then converts it into a digital signal Vs whose frequency and phase are synchronized with that of the analog signal As. The voltage comparator 51, well known in the art and thus not explaining in detail, may be an analog to digital converter. Also, the voltage comparator 51 may further incorporate a circuit capable of eliminating noises, such as a digital filter, to improve the quality of the digital signal Vs. The analog signal As may be a power source.

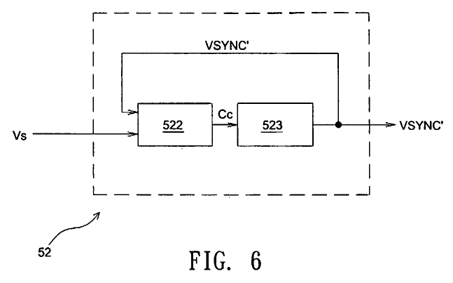

The sensor/video period compensation unit 52 receives the digital signal Vs, generates a vertical synchronous signal VSYNC′, and compensates the period and phase of the vertical synchronous signal VSYNC′ to synchronize the vertical synchronous signal VSYNC′ with the digital signal Vs in frequency and phase. Referring to FIG. 6, the sensor/video period compensation unit 52 includes a phase comparator 522 and an image synchronous signal generator 523. The phase comparator 522 receives the digital signal Vs and the vertical synchronous signal VSYNC′ and compares their periods and phases to generate a clock correction signal Cc. The image synchronous signal generator 523, used for generating the vertical synchronous signal VSYNC′, receives the clock correction signal Cc. Meanwhile, the image synchronous signal generator 523 adjusts the length of a subsequent period of the vertical synchronous signal VSYNC′ according to the clock correction signal Cc. Thus, through the process of repeatedly adjusting the period of the vertical synchronous signal VSYNC′ in reference to the digital signal Vs, the vertical synchronous signal VSYNC′ is synchronized with the analog signal As in frequency and phase. For example, at a time point assume the period of the vertical synchronous signal VSYNC′ lags behind that of the digital signal Vs (synchronized with the analog signal As in frequency) with 100 clocks, the phase comparator 522 will generate a clock correction signal Cc after comparing them and instruct the image synchronous signal generator 523 to shorten the length of a subsequent period of the vertical synchronous signal VSYNC′ with 100 clocks, so that the vertical synchronous signal VSYNC′ is synchronized with the analog signal As in frequency and phase.

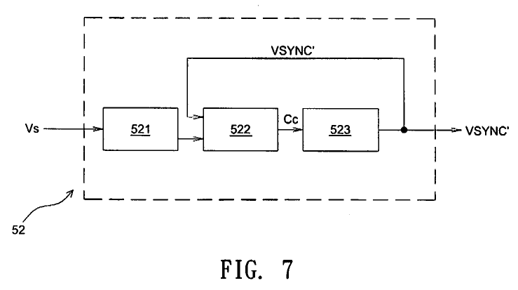

Referring to FIG. 7, the sensor/video period compensation unit 52 may further include a phase adjusting unit 521 for adjusting the phase of the digital signal Vs. The phase adjusting unit 521 receives the digital signal Vs and delays the phase of the digital signal Vs to a preset time point in reference to the period of the digital signal Vs. Certainly, the phase delay value of the digital signal Vs may be set by firmware, software, hardware, or their combination.

The operations regarding image input are described below.

Referring to FIG. 5, the image acquisition device 53 receives vertical synchronous signal VSYNC′ and deals with the image to generate a target image data T′ having improved image quality.

The operations regarding image output are described below.

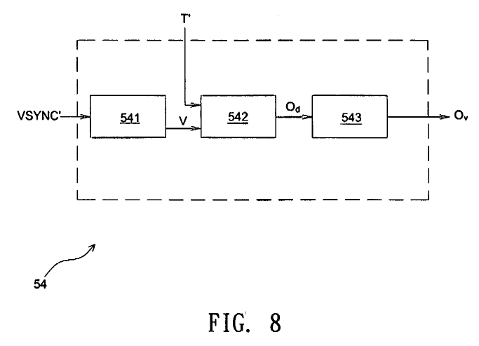

The image output system 50′ receives the vertical synchronous signal VSYNC′ and the target image data T′ and encodes the target image data T′ according to the vertical synchronous signal to generate an analog encoded image data Ov. Referring to FIG. 8, the video encoder 54 includes a video timing generator 541, a luminance/chroma/burst/synchronous signal generator 542, and a digital to analog converter 543. The video timing generator 541 receives the vertical synchronous signal VSYNC′ and generates a video timing V according to the vertical synchronous signal VSYNC′.

The luminance/chroma/burst/synchronous signal generator 542 receives the video timing V and the target image data T′, deals with the integration and encoding for the luminance, chroma, burst, and image synchronization, and then outputs digital encoded image data Od. The digital to analog converter 543 receives and converts the digital encoded image data Od into an analog encoded image data Ov.

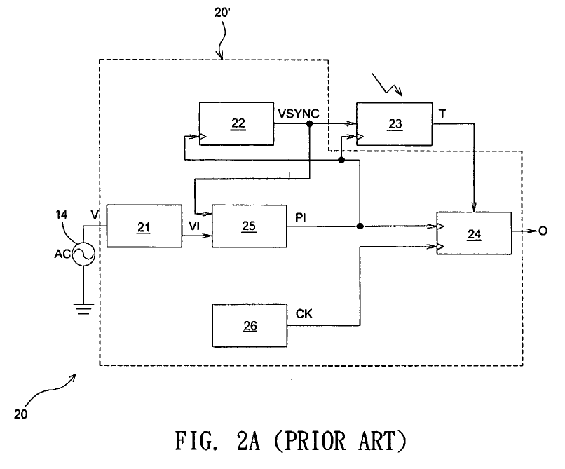

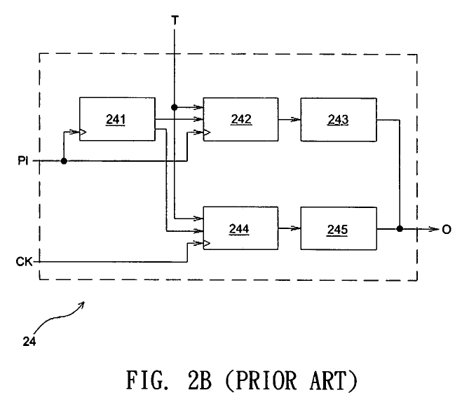

According to the invention, all components in the image output system 50′ operate in reference to the original system clock, thus different to the conventional art where the phase locked loop 25 and the timing generator 26 should be added to provide two different clocks for the video encoder 54. Hence, according to the invention, the chroma and burst managements (implemented by the chroma/burst signal generator 244 shown in FIG. 2B) that demand a considerably small frequency error may adopt the same system clock used in the luminance and synchronization managements (implemented by the luminance/synchronous signal generator 242 shown in FIG. 2B). Thus, the clock generator 26 (shown in FIG. 2A) used for providing accurate system clock signal CK can be omitted, and further the digital to analog converter 245 (shown in FIG. 2B) can be omitted. Therefore, the chroma, burst, luminance and synchronization managements are integrated and implemented by a single luminance/chroma/burst/synchronous signal generator 542, and thus the video encoder 54 needs only one digital to analog converter 543 to perform digital to analog conversion, resulting in a reduced cost for the image output system 50′.

The image output system 50′ differs from the conventional one in that the image output system 50′ uses the sensor/video period compensation unit 52 to compensate the period of the vertical synchronous signal VSYNC′ generated from the image synchronous signal generator 523 in reference to a digital signal Vs (synchronized with the analog signal As in frequency). Hence, the error of the vertical synchronous signal VSYNC′ is limited in a very small range, and the vertical synchronous signal VSYNC′ is capable of being synchronized with the frequency and phase of the analog signal As as the power source bears considerable amount of noises.

Since the improved anti-noise capability of image output system 50′, the image output system thus is capable of being synchronous with power source in frequency and phase, the images acquired from the video cameras 111˜114 are displayed on the display 13 smoothly and steadily without flickering and jittering. Therefore, the problem, which exists in the conventional image output system is that the phase lock loop fails to lock the frequency of the power source and causes image flicker and jitter, is eliminated. Hence, the image output system needs only one digital to analog converter and has a reduced cost.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An image output system, which receives a target image data generated from an image acquisition device and outputs an analog encoded image data, comprising:
a phase comparator for receiving a digital signal and a vertical synchronous signal and comparing their period and phase to generate a clock correction signal, wherein the digital signal is converted from an analog signal through an analog-to-digital conversion;
an image synchronous signal generator for receiving the clock correction signal, generating the vertical synchronous signal, and adjusting a subsequent period of the vertical synchronous signal according to the clock correction signal; and
a video encoder for receiving the vertical synchronous signal and the target image data and encoding the vertical synchronous signal and the target image data to generate analog encoded image data.

2. The image output system as claimed in claim 1, further comprising a phase adjusting unit for receiving the digital signal and delaying the phase of the digital signal.

3. The image output system as claimed in claim 1, wherein the image output system further comprising a voltage comparator for receiving the analog signal and converting the analog signal into the digital signal synchronized with the analog signal in both frequency and phase, wherein the analog signal is a power source.

4. The image output system as claimed in claim 1, wherein the video encoder comprises:
a video timing generator for receiving the vertical synchronous signal and generating a video timing according to the vertical synchronous signal;
a luminance/chroma/burst/synchronous signal generator for receiving the video timing and the target image data, dealing with the integration and encoding for the luminance, chroma, burst, and image synchronization of the video timing and the target image data, and outputting a digital encoded image data; and
a digital to analog converter for receiving and converting the digital encoded image data into the analog encoded image data.
